(19) United States
(12) Patent Application Publication
(10) Pub. No.: US 2013/0033224 A1
(43) Pub. Date: Feb. 7, 2013

(54) METHOD AND APPARATUS FOR ALIGNING A VEHICLE WITH AN INDUCTIVE CHARGING SYSTEM

(71) Applicant: Steven Raedy, Raleigh, NC (US)

(72) Inventor: Steven Raedy, Raleigh, NC (US)

(73) Assignee: EVATRAN LLC, Wytheville, VA (US)

(21) Appl. No.: 13/198,863

(22) Filed: Aug. 5, 2011

(51) Int. Cl. H02J 7/00; G01B 7/14

(52) U.S. Cl. 320/107; 324/207.17

(57) ABSTRACT

A method and apparatus for aligning a vehicle with an inductive charging system is characterized by the addition of alignment coils to a secondary coil on the vehicle. For efficient inductive charging, it is necessary that the vehicle mounted secondary coil be aligned with a stationary primary coil of a transformer of the inductive charging system. When the primary coil is energized, it produces a magnetic field which induces a voltage in the alignment coils as a function of the proximity of the alignment coils to the central axis of the primary coil. The voltage differential between opposed pairs of alignment coils is determined by a comparator which then generates a directional signal which can be used by the operator of the vehicle to position the vehicle for closer alignment of the vehicle secondary coil with the primary coil and more efficient charging.

### BACKGROUND OF THE INVENTION

Electric vehicle energy storage systems are normally recharged using direct contact conductors between an alternating current (AC) source such as is found in most homes in the form of electrical outlets; nominally 120 or 240 VAC. A well known example of a direct contact conductor is a two or three pronged plug normally found with any electrical device. Manually plugging a two or three pronged plug from a charging device to the electric automobile requires that conductors carrying potentially lethal voltages be handled. In addition, the conductors may be exposed, tampered with, or damaged, or otherwise present hazards to the operator or other naïve subjects in the vicinity of the charging vehicle. Although most household current is about 120 VAC single phase, in order to recharge electric vehicle batteries in a reasonable amount of time (two-four hours), it is anticipated that a connection to a 240 VAC source would be required because of the size and capacity of such batteries. Household current from a 240 VAC source is used in most electric clothes dryers and clothes washing machines. The owner/user of the electric vehicle would then be required to manually interact with the higher voltage three pronged plug and connect it at the beginning of the charging cycle, and disconnect it at the end of the charging cycle. The connection and disconnection of three pronged plugs carrying 240 VAC presents an inconvenient and potentially hazardous method of vehicle interface, particularly in inclement weather.

In order to alleviate the problem of using two or three pronged conductors, inductive charging systems have been developed in order to transfer power to the electric vehicle. Inductive charging, as is known to those of skill in the art, utilizes a transformer having primary and secondary windings to charge the battery of the vehicle. The primary winding is mounted in a stationary charging unit where the vehicle is stored and the secondary winding is mounted on the vehicle

To maximize efficiency, it is important that the secondary winding on the vehicle be aligned with the primary winding in the stationary charging unit. The present invention relates to inductive proximity charging. More particularly, the invention relates to a system and for assisting the operator with positioning the vehicle so that the secondary winding thereon is in close proximity and aligned with the stationary primary winding for efficient inductive charging of the vehicle.

### BRIEF DESCRIPTION OF THE PRIOR ART

Inductive charging systems are well known in the prior art. For example, the Partovi US patent application publication No. 2009/0096413 discloses an inductive charging system in which includes a base unit containing a primary coil and mobile device including a secondary winding. To assist with alignment of the mobile device and the base unit, a plurality of alignment magnets are provided behind each coil. The magnets behind the primary and secondary coils are arranged in pairs, respectively, with the poles of each pair being opposite so that the magnets will attract and thus align the coils.

While the prior devices operate satisfactorily, they are not suitable for use in vehicle charging systems. First, the magnets add unnecessary weight to the vehicle coil which decreases the efficiency of the vehicle. Second, the magnets are not strong enough to reposition the vehicle or base unit relative to one another. Third, the magnets generate eddy currents which lead to heating and power loss. While eddy currents may be reduced by providing the magnets in two or more sections with a gap in between, this further increases the cost of the magnets.

The present invention was developed in order to overcome these and other drawbacks of the prior alignment techniques by providing an alignment apparatus which assists the operator of a vehicle in positioning the vehicle so that the secondary coil mounted thereon is in close proximity to and aligned with the stationary primary coil in the base unit for maximum inductive energy transfer to a battery charger on the vehicle.

### SUMMARY OF THE INVENTION

Accordingly, it is a primary object of the invention to provide a method and apparatus for aligning a vehicle with an inductive charging system. The apparatus includes a transformer having a stationary primary coil and a secondary coil mounted on the vehicle. A plurality of alignment coils are equally spaced in the vicinity of the secondary coil. When the primary coil is energized, it generates a magnetic field which induces voltage in the alignment coils as a function of the proximity of each alignment coil to the central axis of the primary coil. The alignment coils are connected with a controller which generates an output signal corresponding to the position of the vehicle relative to the primary coil. The output signal is utilized to communicate information, via a display or the like, which is used by the operator of the vehicle to position the vehicle so that the secondary coil and primary coils are axially aligned.

The alignment coils each have the same diameter which is significantly less than the diameter of the secondary coil. The alignment coils are arranged symmetrically within the vicinity of the secondary coil and have axes which are parallel to the axis of the secondary coil.

A voltage sensor is connected with each alignment coil for measuring the voltage induced in each alignment coil by the primary coil. The voltage sensors are connected with a comparator within the controller. The comparator measures the voltage differential between the voltage sensors to generate a directional signal relative to the axis of the secondary coil. The directional signal contains information which is communicated either wirelessly to an external display or directly to a display within the vehicle to provide a visual indication to the vehicle operator of the direction that the vehicle must be moved in order to bring the vehicle secondary coil into alignment with the stationary primary coil.

The alignment system according to the invention can also be used to determine the presence of foreign metal objects within the inductive poles of the primary and secondary coils. This enables the charging system to be disabled when foreign metal objects are present in order to eliminate the risk of fire or injury resulting from overheating such objects during the charging process.

### BRIEF DESCRIPTION OF THE FIGURES

Other objects and advantages of the present invention will become apparent from a study of the following specification when read in conjunction with the accompanying drawing, in which:

FIG. 1 is a schematic diagram of an inductive vehicle charging system incorporating an alignment system according to the invention;

FIGS. 2 and 3 are top and side views, respectively, of the primary, secondary and alignment coils of the alignment system of FIG. 1; and

FIG. 4 is a schematic diagram of the secondary and alignment coils and controller of the alignment system of FIG. 1.

### DETAILED DESCRIPTION

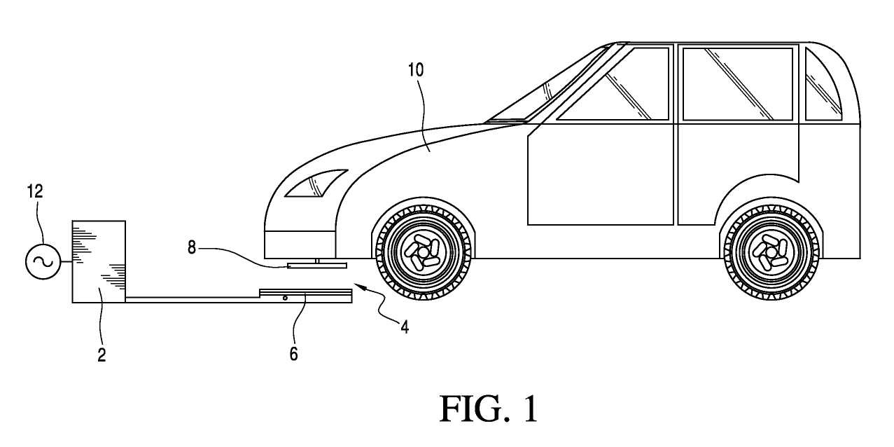

Referring first to FIG. 1, there is shown an inductive charging system for electric vehicles. The system includes a charging station 2 and a transformer 4. The transformer includes a stationary primary coil 6 which is preferably mounted on the ground such as the floor of a garage. The primary coil is connected with the charging station. The transformer further includes a secondary coil 8 which is mounted on a vehicle 10. The secondary coil is mounted at a location on the vehicle so that the vehicle can be positioned adjacent to the charging station with the secondary coil above the primary coil as shown. Preferably, the coils are arranged with their axes in alignment for maximum energy transfer there between. The charging station 2 is connected with a power source 12.

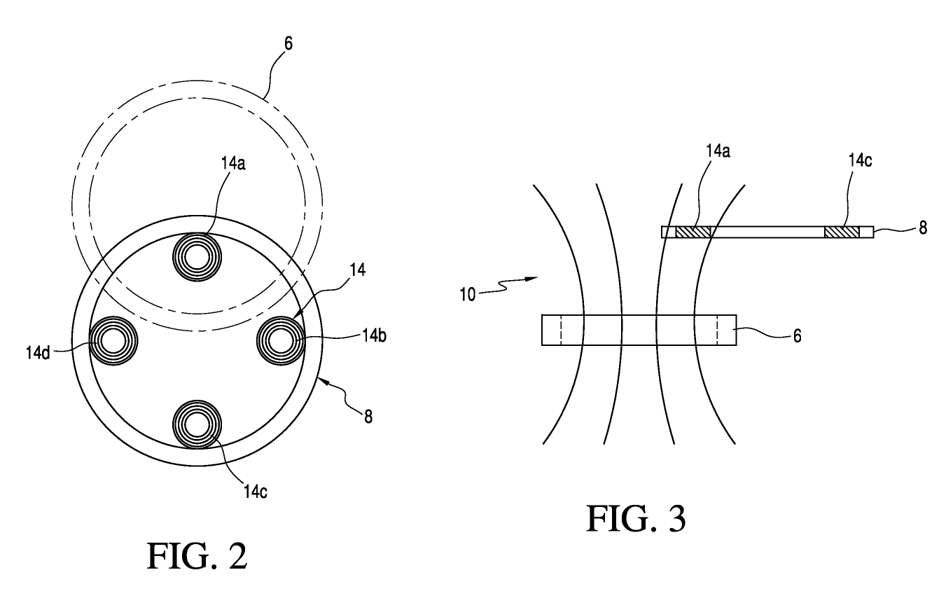

The system for positioning the vehicle to align the vehicle secondary coil 8 with the stationary primary coil 6 will be described with reference to FIGS. 2-4. Referring first to FIGS. 2 and 3, the primary coil 6 when energized produces a magnetic field 10. The secondary coil 8 includes a plurality of alignment coils 14. In the embodiment shown, four alignment coils 14a-d are provided, although it will be appreciated by those of ordinary skill in the art that greater or less than four alignment coils may be provided as will be developed below.

The alignment coils are symmetrically arranged in the vicinity of the secondary coil. In a preferred embodiment shown in FIG. 2, the alignment coils 14 are equally spaced within the inner circumference of the secondary coil 8. The alignment coils are preferably of the same size and configuration and have diameters significantly less than the diameter of the secondary coil. They are preferably arranged adjacent to the inner circumference of the secondary coil and have axes which are parallel to the axis of the secondary coil as shown in FIG. 3. When the primary coil is energized by the charging station 2, voltages are induced in the alignment coils in accordance with the proximity of the alignment coils to the magnetic field 10.

In an alternate embodiment, the alignment coils may be arranged externally of the secondary coil. In either embodiment, the alignment coils are eqully spaced from each other in a symmetrical arrangement relative to the secondary coil as will be developed in greater detail below.

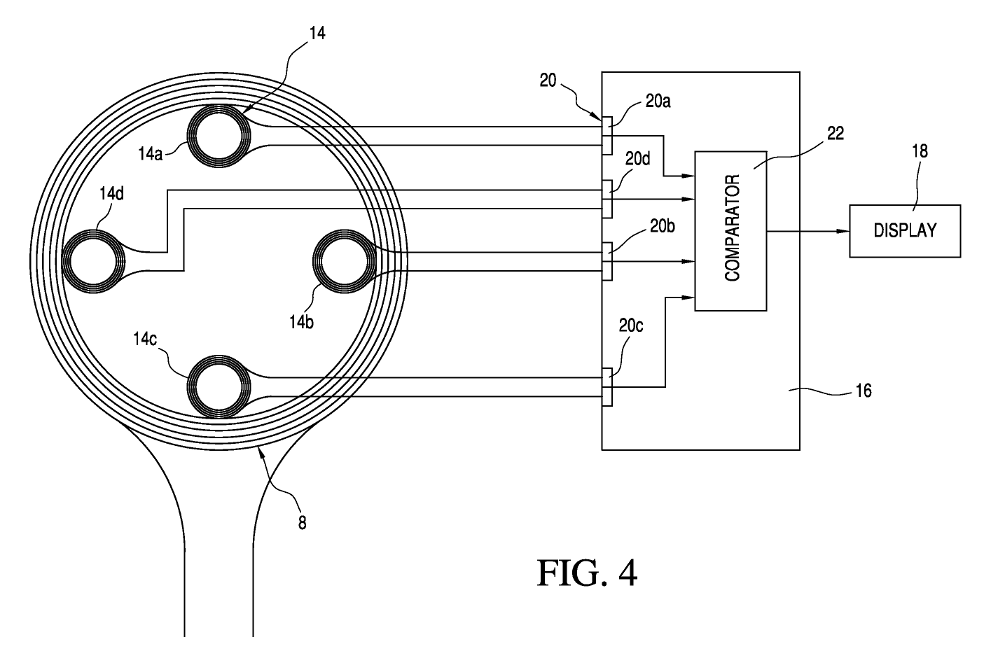

Referring now to FIG. 4, the alignment system according to the invention further includes a controller 16 connected with the secondary coil 8. As will be developed below, the controller generates an output directional signal corresponding to the position of the vehicle secondary coil relative to the primary coil. A display 18 is connected with the controller to provide a visual indication of the output signal which is used by the operator of the vehicle to position the vehicle and axially align the secondary coil with the primary coil for maximum induction energy transfer to the secondary coil to power a battery charger (not shown) on the vehicle. The controller 16 includes plurality of voltage sensors 20 connected with the alignment coils 14. Thus in the embodiment shown, voltage sensors 20a-d are connected with alignment coils 14a-d, respectively. The voltage sensors measure the voltage induced in each coil by the primary coil. The controller also includes a comparator 22 connected with the voltage sensors 20. The comparator measures the voltage differential between the voltage sensors to generate the directional signal.

Preferably, an even number of alignment coils are provided, with the coils on opposite sides of the secondary coil being paired. Thus, in the embodiment shown in FIGS. 2-4, coils 14a and 14c are paired and coils 14b and 14d are paired. Referring to FIG. 3, the voltage induced in coil 14d is greater than the voltage induced in coil 14b because coil 14d is closer to the magnetic field. The comparator 22 measures the voltage differential between the opposed pairs of coils and generates a directional signal for each of the opposed pairs. The directional signals from the opposed pairs of coils are combined by the comparator to generate a composite directional signal which is displayed on the display 18 and used by the operator of the vehicle to position the vehicle secondary coil proximate to the primary coil.

As noted above, the charging station 2 is connected with a power source 12. The power source is preferably a 220 volt AC supply operating at between 50 and 60 Hz. For operation of the alignment system according to the invention, the primary coil 6 is initially energized by the power source and charging station at a reduced voltage so that the magnetic field 10 is produced which is symmetric about the axis of the primary coil. The alignment cols are arranged in the secondary coil so that the magnetic flux produced by the stationary primary coil 6 induces a voltage in each alignment coil which is proportional to its proximity to the center of the primary coil. The voltage sensors 20 measure the relative amount of voltage induced in each alignment coil, and the comparator determines the direction of misalignment based on the voltage differential in the opposed pairs of coils. For example, if the vehicle mounted secondary coil 8 is positioned relative to the stationary primary coil 6 as shown in FIGS. 2 and 3, the voltage induced in alignment coil 14a will be larger than in coil 14c. This information can be used to indicate that the vehicle needs to be moved in the direction of coil 14a in order to improve the alignment. When the voltage in all four alignment coils 14a-d is equal, the vehicle secondary coil 8 will precisely aligned with the stationary primary coil. Once aligned, the power supplied by the power source to the primary coil is increased to begin the charging process. More particularly, the charging station includes a power converter which converts the incoming source voltage from the power supply into a sinusoidal voltage of arbitrary frequency and voltage. The sinusoidal voltage is supplied to the stationary primary coil 6. Current within the primary coil generates a magnetic field which induces a current in the secondary coil 8 mounted on the vehicle. This in turn produces an output voltage which is delivered to a battery charger (not shown) in the vehicle to charge the vehicle battery.

It will be appreciated that the alignment system according to the invention may be provided with only a single pair of opposed alignment coils if only two-direction misalignment information is desired. Additional pairs of alignment coils may be provided for more precise alignment information.

The inductive charging system may complement a conventional conductive charger. The controller 16 is operable to control both types of charging as well as operation of the alignment system. A transfer switch (not shown) on the controller is operable to isolate the charging sources to prevent the user from simultaneously using both inductive and conduction recharging systems.

While the preferred forms and embodiments of the present invention have been illustrated and described, it will be readily apparent to those skilled in the art that various changes and modifications may be made without deviating from the inventive concepts set forth above.

1. Apparatus for aligning a vehicle with an inductive charging system, comprising
(a) a transformer including a stationary primary coil and a secondary coil mounted on the vehicle;
(b) at least one alignment coil arranged in the vicinity of said secondary coil, said primary coil generating a magnetic field when energized to induce a voltage in said alignment coil as a function of its proximity to a central axis of said primary coil; and
(c) a controller connected with said alignment coil for generating an output signal corresponding to the position of the vehicle secondary coil relative to the primary coil, whereby the operator of the vehicle can position the vehicle in accordance with the output signal to axially align said secondary coil with said primary coil for maximum induction energy transfer to the secondary coil to power a battery charger on the vehicle.

2. Apparatus as defined in claim 1, wherein said alignment coil has a diameter less than the diameter of said secondary coil.

3. Apparatus as defined in claim 2, wherein said alignment coil has an axis which is parallel to the axis of said secondary coil.

4. Apparatus as defined in claim 19, wherein four alignment coils are provided in the vicinity of said secondary coil, said alignment coils being arranged in quadrants.

5. Apparatus as defined in claim 3, wherein said controller includes a voltage sensor connected with said alignment coil for measuring the voltage induced therein by said primary coil.

6. Apparatus as defined in claim 19, wherein said controller includes voltage sensors connected with said alignment coils, respectively, and a comparator connected with said voltage sensors, said comparator measuring the voltage differential between said voltage sensors to generate a directional signal relative to the axis of said secondary coil.

7. Apparatus as defined in claim 6, wherein said alignment coils are arranged in opposed pairs, said comparator measuring the voltage differential between opposed pairs of alignment coils to generate directional signals for each opposed pair of alignment coils, said comparator further combining said directional signals to generate a composite directional signal used by the operator of the vehicle to position the vehicle secondary coil proximate said primary coil.

8. Apparatus as defined in claim 3, and further comprising a power source connected with said primary coil for energizing said primary coil at a first voltage level to produce a first magnetic field to induce a voltage in said alignment coil and for energizing said primary coil at a second voltage level greater than said first voltage level to produce a second magnetic field greater than said first magnetic field to induce a voltage in said secondary coil to power the battery charger.

9. Apparatus as defined in claim 3, wherein said alignment coil is arranged within said secondary coil.

10. Apparatus as defined in claim 9, wherein said alignment coil is completely contained with the inner perimeter of said secondary coil.

11. Apparatus as defined in claim 10, wherein said alignment coil is arranged adjacent to an inner circumference of said secondary coil.

12. A method for aligning a vehicle having a secondary coil mounted thereon with a primary coil of an inductive charging system, comprising the steps of
(a) providing at least one alignment coil in the vicinity of the secondary coil;
(b) energizing the primary coil to generate a magnetic field which induces a voltage in said alignment coil as a function of the proximity of said alignment coil to a central axis of the primary coil; and
(c) processing said voltage from said alignment coil to produce an output signal corresponding to the position of the vehicle secondary coil relative to the primary coil, whereby the operator of the vehicle can position the vehicle in accordance with the output signal to align the secondary coil with the primary coil for maximum induction energy transfer to the secondary coil to power a battery charger on the vehicle.

13. A method as defined in claim 17, wherein the alignment coils are arranged in opposed pairs, and said processing step includes measuring the voltage differential between the opposed pairs of alignment coils to generate directional signals for each opposed pair of alignment coils.

14. A method as defined in claim 13, and further comprising the step of combining the directional signals to generate a composite directional signal which is used by the operator of the vehicle to position the vehicle.

15. A method as defined in claim 14, and further comprising the step of displaying said directional signal on a display.

16. A method as defined in claim 12, and further comprising a plurality of alignment coils.

17. A method as defined in claim 16, wherein the alignment coils are equally spaced relative to the secondary coil.

18. Apparatus as defined in claim 1, and further comprising a plurality of alignment coils.

19. Apparatus as defined in claim 16, wherein said alignment coils are equally spaced relative to said secondary coil.
